(19) United States
(12) Patent Application Publication
(10) Pub. No.: US 2007/0136003 A1
(43) Pub. Date: Jun. 14, 2007

(54) Method and system of verifying protein-protein interaction using protein homology relationship

(75) Inventors: Jae Hun Choi, Daejeon-city (KR); Jong Min Park, Jeonju-city (KR); Seon Hee Park, Daejeon-city (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/635,581

(22) Filed: Dec. 8, 2006

(30) Foreign Application Priority Data
Dec. 8, 2005 (KR) 10-2005-0119280
Mar. 21, 2006 (KR) 10-2006-0025682

(51) Int. Cl. G06F 19/00

(52) U.S. Cl. 702/19

(57) ABSTRACT

Provided are a method and system for verifying a protein-protein interaction of a species by using a homology relationship between proteins of the species and proteins of other species. The method includes generating one or more protein homology relationships between source proteins of a species and heterogeneous proteins of one or more other species, generating one or more heterogeneous protein interactions corresponding to a specific source protein interaction using the generated one or more protein homology relationships, and determining whether the generated one or more heterogeneous protein interactions are present between the heterogeneous proteins of one or more species. Accordingly, a protein-protein interaction of a specific high-rank organism can be automatically verified by using protein-protein interactions of a low-rank organism that can be easily determined at low costs, without an expensive biological experiment.

### CROSS-REFERENCE TO RELATED PATENT APPLICATION

This application claims the priorities of Korean Patent Application No. 10-2005-0119280, filed on Dec. 8, 2005 and Korean Patent Application No. 10-2006-0025682, filed on Mar. 21, 2006, in the Korean Intellectual Property Office, the disclosures of which are incorporated herein in their entirety by reference.

### BACKGROUND OF THE INVENTION

1. Field of the Invention

The present invention relates to a method and system of verifying a protein-protein interaction.

2. Description of the Related Art

Protein is a material which is generated by the expression of a gene, which performs inherent functions in a living body and plays a leading role for various living organisms while organically interacting with other proteins. For example, a signal transmission for transmitting a bio-signal to a nucleus, thus causing a biological phenomenon to occur, the life period and development of a cell, metabolism, etc. are performed through complicated interactions among a plurality of proteins. Accordingly, contemporary biological science has focused on complicated interactions between genes or proteins, rather than on only individual genes or proteins, in order to investigate life phenomena from a more general view.

A protein-protein interaction may be defined as an interaction involving several proteins for a specific biological process in a living organism. That is, a protein-protein interaction may be understood as an interaction in which a protein reacts with another specific protein. In general, a protein-protein interaction is analyzed through high-throughput screening such as yeast two hybrids. However, the analysis result (data) contains a lot of false positives that are not substantial protein-protein interaction results. A biological test, such as co-immunoprecipitation, may be performed to detect the false positives but is expensive since the scale of protein-protein interactions is very large.

At the present time, a large amount of researches has been conducted into estimation of protein-protein interactions, not verification thereof. Estimation methods of protein-protein interactions are largely categorized into a mechanical learning method and a protein homology method. However, these methods also give many false positives. Therefore, a method of verifying protein-protein interactions must be developed to secure data reliability.

In the mechanical learning method, since protein is described regarding characteristics thereof (rank, domain, expression, etc.), the existing protein-protein interactions disclosed through experiments can be expressed using data related to the characteristics. A rule regarding the characteristics can be extracted from the data related to the characteristics through mechanical learning, and other protein-protein interactions can be estimated from the rule. However, this method can give false positives that significantly lower the reliability of the method when the range of the rule is increased, and false negatives that significantly reduce the scope of the rule when increasing the reliability of the method.

### SUMMARY OF THE INVENTION

The present invention provides a method of verifying an interaction between proteins of a species, which was extracted through a biological experiment, at low cost, based on already disclosed interactions among proteins of various species

The present invention also provides a system for verifying an interaction between proteins of a species, which was extracted through a biological experiment, at low costs, based on already disclosed interactions among proteins of various species.

According to an aspect of the present invention, there is provided a method of verifying protein-protein interactions, the method comprising (a) generating one or more protein homology relationships between source proteins of a species and heterogeneous proteins of one or more other species; (b) generating one or more heterogeneous protein interactions corresponding to a specific source protein interaction using the generated one or more protein homology relationships; and (c) determining whether the generated one or more heterogeneous protein interactions are present between the heterogeneous proteins of one or more species.

(a) may comprise (a1) filtering all of heterogeneous proteins of other species to select heterogeneous proteins being highly related to the source proteins of a species; (a2) comparing whether a homology relationship is present between the source proteins and the selected heterogeneous proteins; and (a3) setting the homology relationship between the source proteins and the heterogeneous proteins when it is determined in (a2) that the homology relationship is present.

(a1) may comprise filtering heterogeneous proteins by using the names of proteins and the names of genes constituting the proteins; and filtering heterogeneous proteins by using definitions mapped to the proteins.

(a2) may comprise comparing whether two heterogeneous proteins have a homology relationship by using the names of proteins and the names of genes constituting the proteins; comparing whether two heterogeneous proteins have a homology relationship by using definitions mapped to the proteins; comparing whether two heterogeneous proteins have a homology relationship by using features of a sequence of the proteins; and comparing whether two heterogeneous proteins have a homology relationship using the sequence of the proteins.

(b) may comprise (b1) detecting two homology proteins of other species which respectively have a homology relationship with two proteins related to the specific source protein interaction; and (b2) setting an interaction between the detected homology proteins.

(c) may comprise (c1) determining whether the generated interactions are present between of the heterogeneous proteins of the one or more species; (c2) increasing a reliability value of the generated interactions when the generated interactions are present between the heterogeneous proteins of the one or more species, and lowering the reliability value of the generated interaction otherwise; and (c3) verifying the specific source protein interaction according to the reliability value of the generated interactions.

According to another aspect of the present invention, there is provided a system for verifying protein-protein interactions, the system comprising a protein information database storing information regarding proteins of a plurality of species; a protein-protein interaction database storing information regarding interactions among proteins of a plurality of species; a homology relationship generation unit generating one or more protein homology relationships between source proteins of a species and heterogeneous proteins of one or more species; an interaction generation unit generating one or more heterogeneous protein interactions corresponding to a specific source protein interaction using the generated one or more homology relationships; and an interaction evaluation unit determining whether the generated one or more heterogeneous protein interactions are present between the heterogeneous proteins of one or more other species based on the protein-protein interaction database.

The system may further comprise a protein homology relationship database storing information regarding the homology relationships generated by the homology relationship generation unit.

The homology relationship generation unit may performs (a1) filtering all of heterogeneous proteins of other species to select heterogeneous proteins being highly related to the source proteins of a species; (a2) comparing whether a homology relationship is present between the source proteins and the selected heterogeneous proteins; and (a3) when it is determined in (a2) that the homology relationship is present, setting the homology relationship between the source proteins and the selected heterogeneous proteins.

The interaction generation unit may performs (b1) detecting two homology proteins of other species which respectively have a homology relationship with two proteins related to the specific source protein interaction; and (b2) setting an interaction between the detected homology proteins.

The interaction evaluation unit may perform (c1) determining whether the generated interactions are present between the heterogeneous proteins of the one or more species; (c2) increasing a reliability value of the generated interactions when the generated interactions are present between the heterogeneous proteins of the one or more other species, and lowering the reliability value of the generated interaction otherwise; and (c3) verifying the specific source protein interaction according to the reliability value of the generated interactions.

### BRIEF DESCRIPTION OF THE DRAWINGS

The above and other aspects and advantages of the present invention will become more apparent by describing in detail exemplary embodiments thereof with reference to the attached drawings in which:

FIG. 1 is a flowchart illustrating a method of verifying a protein-protein interaction according to an embodiment of the present invention;

FIG. 2 is a flowchart illustrating operation S100 of FIG. 1 in more detail according to an embodiment of the present invention;

FIG. 3 is a flowchart illustrating operation S120 of FIG. 2 in more detail according to an embodiment of the present invention;

FIG. 4 is a flowchart illustrating operation S130 of FIG. 2 in more detail according to an embodiment of the present invention;

FIG. 5 is a flowchart illustrating operation S200 of FIG. 1 in more detail according to an embodiment of the present invention;

FIG. 6 is a flowchart illustrating operation S300 of FIG. 1 in more detail according to an embodiment of the present invention; and

FIG. 7 is a block diagram of a system for verifying a protein-protein interaction according to an embodiment of the present invention.

### DETAILED DESCRIPTION OF THE INVENTION

Hereinafter, exemplary embodiments of the present invention will be described in detail with reference to the accompanying drawings.

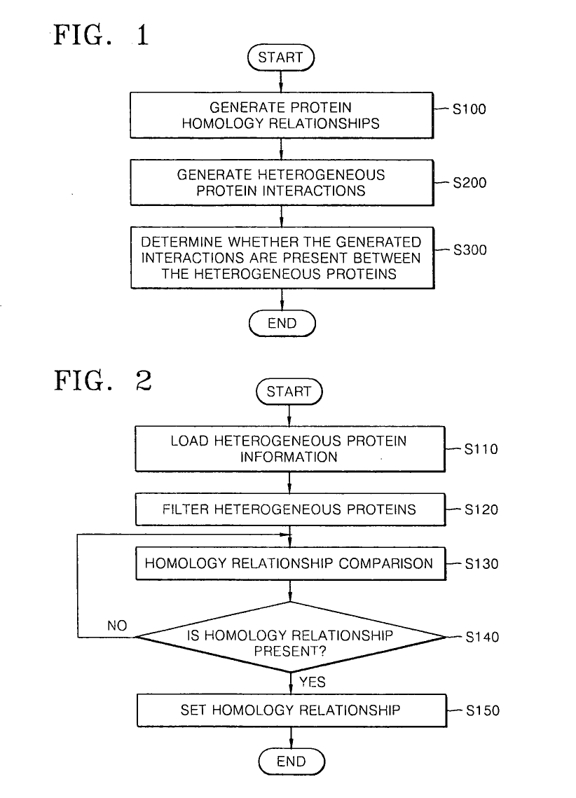

FIG. 1 is a flowchart illustrating a method of verifying a protein-protein interaction according to an embodiment of the present invention. In the method illustrated in FIG. 1, first, one or more homology relationships between source proteins of a species and heterogeneous proteins of one or more other species are generated (S100). Operation S100 may be performed by using a protein information database that stores information regarding proteins of a plurality of species. Alternatively, information regarding the generated homology relationships may be stored in a protein homology relationship database.

Next, one or more heterogeneous protein interactions corresponding to specific source protein interactions, are generated based on the generated homology relationships (S200).

Next, it is determined whether the generated interactions are also present between the heterogeneous proteins of the one or more species (S300). If the generated interactions are substantially present between the one or more species of the heterogeneous proteins, the interaction between the specific source proteins can be verified. Operation S300 may be performed by using a protein-protein interaction database that stores information regarding interactions among proteins of a plurality of species.

FIG. 2 is a flowchart illustrating operation S100 of FIG. 1 in more detail according to an embodiment of the present invention. Referring to FIG. 2, information regarding all of proteins of various species is downloaded from the protein information database (S110). Next, the downloaded information is filtered to select only heterogeneous proteins that are highly related to the source proteins (S120). Next, the source proteins and the selected heterogeneous proteins are compared to determine whether they have a homology relationship (S130). In this case, a plurality of heterogeneous proteins may be detected with respect to a source protein. If heterogeneous proteins similar to the source proteins are detected and the homology of the source proteins and the heterogeneous proteins has a value equal to or greater than a specific threshold (S140), it is determined that the source proteins and the heterogeneous proteins have the homology relationship (S150). If determined otherwise in operation S140, the source proteins are compared to other proteins to determine whether the homology relationship can be found (S130). The information regarding the homology relationship may be stored in the homology relationship database.

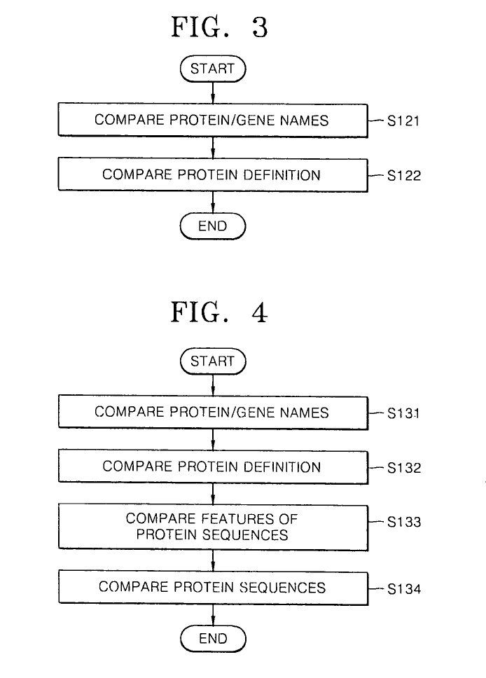

FIG. 3 is a flowchart illustrating operation S120 of FIG. 2 in more detail according to an embodiment of the present invention. Referring to FIG. 3, operation S120 may include filtering heterogeneous proteins based on the names of proteins and genes constituting the proteins (S121), and filtering heterogeneous proteins based on definitions mapped to the proteins (S122).

FIG. 4 is a flowchart illustrating operation S130 of FIG. 2 in more detail according to an embodiment of the present invention. Referring to FIG. 4, first, only meaningful parts are extracted from the names of a source protein and a heterogeneous protein, and the extracted parts are compared to determine a degree of the similarity between them (S131). In operation S131, the names of genes constituting these proteins are also compared to determine the similarity between them (S131). Next, the definitions of ontology terms given to these proteins are compared to determine the similarity between them (S132), and features of sequences of the proteins are compared to determine the similarity between them (S133). The more features that the proteins have that are identical, the higher the probability that these proteins will interact in an identical way. Next, it is determined whether the sequences of these proteins are identical by using a conventional sequence comparing algorithm, such as BLAST (S134).

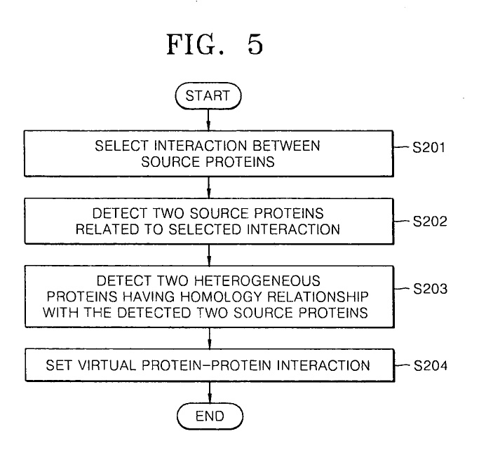

FIG. 5 is a flowchart illustrating operation S200 of FIG. 1 in more detail according to an embodiment of the present invention. Referring to FIG. 5, first, an interaction between source proteins of a species to be verified is selected (S201). Next, two source proteins related to the selected interaction are detected (S202). Next, heterogeneous proteins having the homology relationship with the two detected source proteins are detected based on information regarding the protein homology relationship generated in operation S100 (S203). Thereafter, a virtual protein-protein interaction is set by using the detected two species of the heterogeneous proteins (S204).

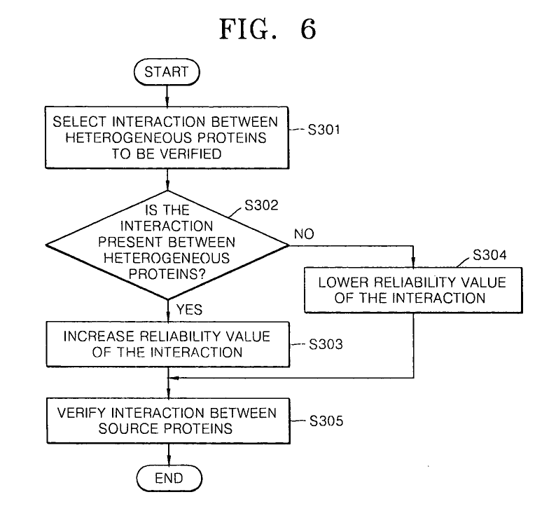

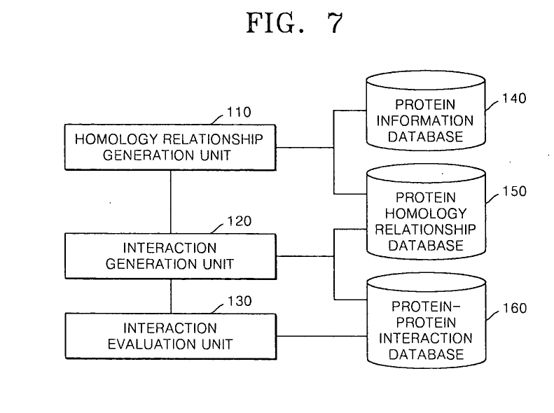

FIG. 6 is a flowchart illustrating operation S300 of FIG. 1 in more detail according to an embodiment of the present invention. Referring to FIG. 6, an interaction between heterogeneous proteins to be verified, is selected (S301). Next, it is determined whether the selected interaction is present between heterogeneous proteins (S302). If it is determined in operation S302 that the selected interaction is present, the reliability of the interaction between the source proteins is increased (S303). If it is determined in operation S302 that the selected interaction is not present, the reliability of the interaction between the source proteins is lowered (S304). Next, the interaction between the source proteins is verified according to the determined reliability (S305).

The method of FIG. 1 is preferably performed on all species of proteins that can be detected. That is, if information regarding a source protein-protein interaction is available on various species of proteins, the reliability of the source protein-protein interaction can be determined to be high without any biological experiment being performed.

FIG. 7 is a block diagram of a system 100 for verifying a protein-protein interaction according to an embodiment of the present invention. Referring to FIG. 7, the system 100 includes a protein information database 140 that stores information regarding proteins of a plurality of species; a protein-protein interaction database 160 that stores information regarding interactions between proteins of a plurality of species; a homology relationship generation unit 110 that generates one or more homology relationships between source proteins of a species and heterogeneous proteins of one or more species, and filtering heterogeneous proteins of various species stored in the protein information database 140 to obtain heterogeneous proteins being highly related to source proteins of a species; a interaction generation unit 120 that generates one or more interactions between heterogeneous proteins corresponding to a specific source protein-protein interaction by using the generated homology relationships; and a interaction evaluation unit 130 that determines whether the one or more interactions between the heterogeneous proteins are present between the heterogeneous proteins of the one or more species based on the protein-protein interaction database 160.

SWISS PROT may be used as the protein information database 140, and the Database of Interacting Protein (DIP), the Biological Interaction Network Database (BIND), or INTERACT may be used as the protein-protein interaction database 160.

The system 100 may further include a protein homology relationship database 150 that stores information regarding the homology relationships generated by the homology relationship generation unit 110.

The homology relationship generation unit 110 may filtering all of heterogeneous proteins of various species to select heterogeneous proteins being highly related to source proteins of a species, compare the source proteins with the selected heterogeneous proteins to determine whether they have the homology relationship, and set the homology relationship when the source proteins and the selected proteins have the homology relationship.

The interaction generation unit 120 may detect two homogenous proteins of different species respectively having the homology relationship with two proteins related to the specific source protein-protein interaction, and set the interaction between the detected homogenous proteins.

The interaction evaluation unit 130 may determine whether the generated one or more protein-protein interactions are present between the heterogeneous proteins of the one or more species increase the reliability value of the interactions when the interactions are present between the heterogeneous proteins of the one or more species and lowers the reliability value of the interactions otherwise, and verify the interaction between the source proteins according to the determined reliability.

The present invention can be embodied as computer readable code in a computer readable medium. Here, the computer readable medium may be any recording apparatus capable of storing data that is read by a computer system, e.g., a read-only memory (ROM), a random access memory (RAM), a compact disc (CD)-ROM, a magnetic tape, a floppy disk, an optical data storage device, and so on. Also, the computer readable medium may be a carrier wave that transmits data via the Internet, for example. The computer readable medium can be distributed among computer systems that are interconnected through a network, and the present invention may be stored and implemented as a computer readable code in the distributed system.

As described above, according to the present invention, a protein-protein interaction of a specific high-grade organism can be automatically verified by using protein-protein interactions of a low-grade organism that can be easily performed at low costs, without an expensive biological experiment. A method of verifying a protein-protein interaction based on protein homology information according to the present invention has an advantage in that a large number of false positives included in a biological experiment can be compensated for at low costs. When the present invention is applied to the field of clinical medicine, it is possible to easily obtain precise protein-protein interaction data used for high-value added medical diagnoses or development of a new medicine.

While this invention has been particularly shown and described with reference to preferred embodiments thereof, it will be understood by those skilled in the art that various changes in form and details may be made therein without departing from the spirit and scope of the invention as defined by the appended claims.

What is claimed is:

1. A method of verifying protein-protein interactions, comprising:
(a) generating one or more protein homology relationships between source proteins of a species and heterogeneous proteins of one or more other species;
(b) generating one or more heterogeneous protein interactions corresponding to a specific source protein interaction using the generated one or more protein homology relationships; and
(c) determining whether the generated one or more heterogeneous protein interactions are present between the heterogeneous proteins of one or more species.

2. The method of claim 1, wherein (a) comprises:
(a1) filtering all of heterogeneous proteins of other species to select heterogeneous proteins being highly related to the source proteins of a species;
(a2) comparing whether a homology relationship is present between the source proteins and the selected heterogeneous proteins; and
(a3) setting the homology relationship between the source proteins and the heterogeneous proteins when it is determined in (a2) that the homology relationship is present.

3. The method of claim 2, wherein (a1) comprises:
filtering heterogeneous proteins by using the names of proteins and the names of genes constituting the proteins; and
filtering heterogeneous proteins by using definitions mapped to the proteins.

4. The method of claim 2, wherein (a2) comprises:
comparing whether two heterogeneous proteins have a homology relationship by using the names of proteins and the names of genes constituting the proteins;
comparing whether two heterogeneous proteins have a homology relationship by using definitions mapped to the proteins;
comparing whether two heterogeneous proteins have a homology relationship by using features of a sequence of the proteins; and
comparing whether two heterogeneous proteins have a homology relationship using the sequence of the proteins.

5. The method of claim 1, wherein (b) comprises:
(b1) detecting two homology proteins of other species which respectively have a homology relationship with two proteins related to the specific source protein interaction; and
(b2) setting an interaction between the detected homology proteins.

6. The method of claim 1, wherein (c) comprises:
(c1) determining whether the generated interactions are present between of the heterogeneous proteins of the one or more species;
(c2) increasing a reliability value of the generated interactions when the generated interactions are present between the heterogeneous proteins of the one or more species, and lowering the reliability value of the generated interaction otherwise; and
(c3) verifying the specific source protein interaction according to the reliability value of the generated interactions.

7. A system for verifying protein-protein interactions, comprising:
a protein information database storing information regarding proteins of a plurality of species;
a protein-protein interaction database storing information regarding interactions among proteins of a plurality of species;
a homology relationship generation unit generating one or more protein homology relationships between source proteins of a species and heterogeneous proteins of one or more species;
an interaction generation unit generating one or more heterogeneous protein interactions corresponding to a specific source protein interaction using the generated one or more homology relationships; and
an interaction evaluation unit determining whether the generated one or more heterogeneous protein interactions are present between the heterogeneous proteins of one or more other species based on the protein-protein interaction database.

8. The system of claim 7, further comprising a protein homology relationship database storing information regarding the homology relationships generated by the homology relationship generation unit.

9. The system of claim 7, wherein the homology relationship generation unit performs:
(a1) filtering all of heterogeneous proteins of other species to select heterogeneous proteins being highly related to the source proteins of a species;
(a2) comparing whether a homology relationship is present between the source proteins and the selected heterogeneous proteins; and
(a3) when it is determined in (a2) that the homology relationship is present, setting the homology relationship between the source proteins and the selected heterogeneous proteins.

10. The system of claim 7, wherein the interaction generation unit performs:
(b1) detecting two homology proteins of other species which respectively have a homology relationship with two proteins related to the specific source protein interaction; and
(b2) setting an interaction between the detected homology proteins.

11. The system of claim 7, wherein the interaction evaluation unit performs:
(c1) determining whether the generated interactions are present between the heterogeneous proteins of the one or more species;
(c2) increasing a reliability value of the generated interactions when the generated interactions are present between the heterogeneous proteins of the one or more other species, and lowering the reliability value of the generated interaction otherwise; and
(c3) verifying the specific source protein interaction according to the reliability value of the generated interactions.
